(19) United States
(12) Patent Application Publication
(10) Pub. No.: US 2026/0122374 A1
(43) Pub. Date: Apr. 30, 2026

(54) IMAGE SENSOR, SOLID-STATE IMAGE CAPTURING DEVICE INCLUDING IMAGE SENSOR, AND METHOD OF CONTROLLING IMAGE SENSOR

(71) Applicants: Kabushiki Kaisha Toshiba, Kawasaki-shi (JP); Toshiba Electronic Devices & Storage Corporation, Kawasaki-shi (JP)

(72) Inventor: Keisuke FUCHIDA, Fujisawa Kanagawa (JP)

(21) Appl. No.: 19/312,049

(22) Filed: Aug. 27, 2025

(30) Foreign Application Priority Data
Oct. 30, 2024 (JP) 2024-190379

(51) Int. Cl. H04N 25/771; H04N 23/84; H04N 25/53; H04N 25/58

(52) U.S. Cl. CPC H04N 25/771; H04N 23/84; H04N 25/53; H04N 25/58

(57) ABSTRACT

According to one embodiment, an image sensor includes a plurality of solid-state image capturing elements arranged as pixels in a row. A storage unit is provided for storing charges for each solid-state image capturing element. A charge-voltage conversion unit is provided that converts charges in each storage unit into a voltage signal. A first photodiode shift gate for an odd-numbered pixel is provided to transfer pixel charges to the respective storage unit. A second photodiode shift gate for an even-numbered pixel to transfer pixel charges to the respective storage unit. A first shift gate for the odd-numbered pixel and second shift gate for the even-numbered pixel is provided to transfer charge to the charge-voltage conversion unit from the respective storage units. A signal processing unit is provided that outputs the voltage signals obtained from the odd-numbered pixels and the even-numbered pixels.

### CROSS-REFERENCE TO RELATED APPLICATION

This application is based upon and claims the benefit of priority from Japanese Patent Application No. 2024-190379, filed Oct. 30, 2024, the entire contents of which are incorporated herein by reference.

### FIELD

Embodiments described herein relate generally to an image sensor, a solid-state image capturing device including an image sensor, and a method of controlling an image sensor.

### BACKGROUND

A method of performing additive color synthesis of image signals obtained from reflected light from different light sources of a plurality of colors is known as a method for obtaining an image using a single inexpensive monochrome single-line sensor. However, acquiring a color image via this method requires time to acquire the multiple image signals of each different light source and faces problems related to occurrence of color shifts and moire fringe effects.

### BRIEF DESCRIPTION OF THE DRAWINGS

FIG. 1 is a block diagram of a solid-state image capturing device including an image sensor according to a first embodiment.

FIG. 2 is a block diagram of an image sensor according to a first embodiment.

FIG. 3 depicts a monochrome single-line sensor of an image sensor according to a first embodiment.

FIG. 4 is a block diagram of a control configuration of an image sensor according to a first embodiment.

FIG. 5 is a flowchart of a read operation in a solid-state image capturing device including an image sensor according to a first embodiment.

FIG. 6 is a block diagram showing a control configuration of an image sensor according to a comparative example.

FIG. 7 is a diagram showing a timing chart of a read operation in an image sensor according to a comparative example.

FIG. 8 is a timing chart of a read operation in an image sensor according to a first embodiment.

FIG. 9 is a diagram showing a signal pattern of an image sensor according to a comparative example.

FIG. 10 is a diagram showing a signal pattern of an image sensor according to a first embodiment.

FIG. 11 is a diagram showing a signal pattern after a signal of an image sensor according to a first embodiment is complemented.

FIG. 12 is a diagram showing a signal pattern of an image sensor according to a first modification example.

FIG. 13 is a diagram showing a signal pattern after a signal of an image sensor according to a first modification example is complemented.

FIG. 14 is a timing chart of a read operation of an image sensor according to a second embodiment.

FIG. 15 is a diagram showing a signal pattern of an image sensor according to a second embodiment.

### DETAILED DESCRIPTION

Embodiments describe an image sensor, a solid-state image capturing device including an image sensor, and a method of controlling an image sensor capable of reducing occurrence of a color shift and moire effects.

In general, according to one embodiment, an image sensor includes a plurality of solid-state image capturing elements arranged as pixels in a row and a storage unit for each solid-state image capturing element to store charges from the respective solid-state image capturing element. A charge-voltage conversion unit that converts the charges in each storage unit into a voltage signal is provided. A first photodiode shift gate that transfers charges stored in an odd-numbered pixel of the plurality of solid-state image capturing elements to the respective storage unit is provided. A second photodiode shift gate that transfers charges stored in an even-numbered pixel of the plurality of solid-state image capturing elements to the respective storage unit is provided. A first shift gate is provided to transfers the charges stored in the storage unit for the odd-numbered pixel to the charge-voltage conversion unit. A second shift gate is provided that transfers the charges stored in the storage unit for the even-numbered pixel to the charge-voltage conversion unit. A signal processing unit is provided to output the voltage signals obtained from the odd-numbered pixels and the even-numbered pixels of the plurality of solid-state image capturing elements.

Hereinafter, certain example embodiments will be described with reference to the drawings. In this description, parts that are substantially the same will be designated by common reference symbols throughout the drawings. The example embodiments do not limit the present disclosure. Furthermore, the drawings are schematic and thus such things as dimensional ratios used in the drawings do not necessarily reflect an actual implementation of an embodiment unless otherwise noted.

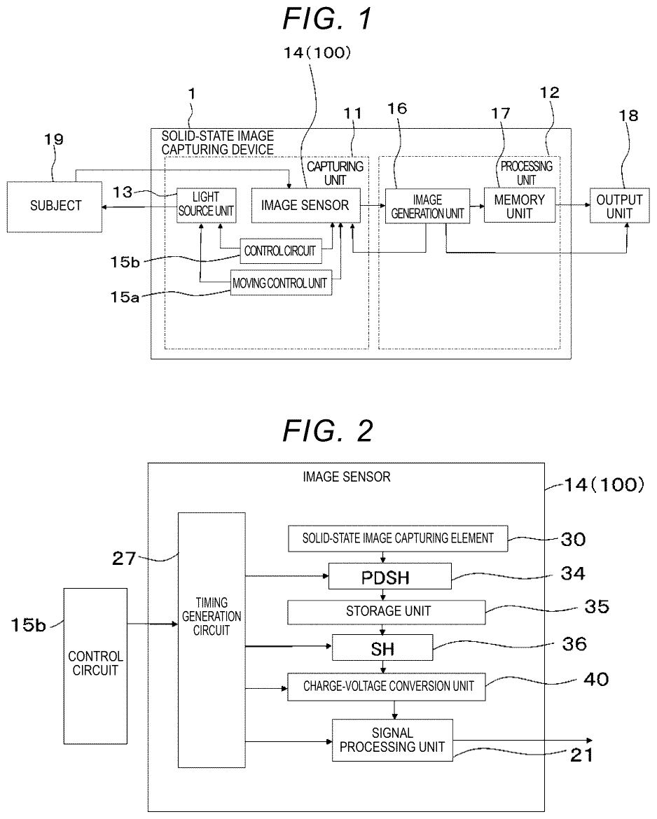

A solid-state image capturing device according to one embodiment will be described below with reference to FIG. 1.

FIG. 1 is a block diagram showing a schematic configuration of a solid-state image capturing device 1 including an image sensor 14 according to an embodiment. As shown in FIG. 1, the solid-state image capturing device 1 includes an image capturing unit 11 and a processing unit 12.

The image capturing unit 11 includes a light source unit 13, an image sensor 14, a moving control unit 15a, and a control circuit 15b. The light source unit 13 can selectively emit light of different colors at a subject 19 (e.g., an external object to be imaged). The image sensor 14 reads (receives) reflected light from the subject 19. The image sensor 14 transmits a signal obtained in imaging process to the processing unit 12.

The processing unit 12 includes an image generation unit 16 and a memory unit 17. The image generation unit 16 can be a processor such as an image signal processor (ISP) that processes the signal from the image sensor 14. For example, the image generation unit 16 performs image quality enhancing processing such as additive color synthesis, noise removal processing, defective pixel correction processing, and resolution conversion processing.

In this example, image generation unit 16 generates an image signal by performing an additive color synthesis processing on the incoming signal, and stores this image signal in the memory unit 17. The image signal may be fed back from the image generation unit 16 to the image capturing unit 11 and used for adjusting and/or controlling the image sensor 14.

The memory unit 17 stores the image signal from the image generation unit 16 as an image. The memory unit 17 outputs an image signal corresponding the stored image to an output unit 18 in accordance with an operation, request, or the like of a user. The output unit 18 can display an image in accordance with the image signal from the image generation unit 16 or the memory unit 17. For example, the output unit 18 is a host computer or a liquid crystal display.

Next, the image sensor 14 provided in the image capturing unit 11 will be described with reference to FIG. 2. FIG. 2 is a block diagram showing a schematic configuration of the image sensor 14 according to this embodiment. The image sensor 14 shown in FIG. 2 is incorporated into the solid-state image capturing device 1 as an image sensor. For example, the image sensor 14 is mounted on a substrate as a packaged electronic component. The image sensor 14 can be electrically connected to an external control circuit or the like.

The image sensor 14 according to the present embodiment is not limited to a front-illuminated complementary metal-oxide-semiconductor (CMOS) image sensor and may be any other image sensor type, such as a back-illuminated CMOS image sensor or a charge coupled device (CCD) image sensor.

The image sensor 14 includes a solid-state image capturing element 30, a photodiode shift gate (PDSH) 34, a storage unit 35, a shift gate (SH) 36, a charge-voltage conversion unit 40, a signal processing unit 21, and a timing generation circuit 27.

The solid-state image capturing element 30 is provided in an imaging area of the image sensor 14. The solid-state image capturing element 30 can be a photodiode that is a photoelectric conversion element. A plurality of photodiodes can be horizontally arranged in a row. In the solid-state image capturing element 30, each photoelectric conversion element corresponding to a pixel generates charges (for example, electrons) corresponding to an incident light quantity.

The pixel charges generated from the solid-state image capturing element 30 are temporarily stored in the storage unit 35. The stored charges are converted into a voltage signal by the charge-voltage conversion unit 40 and are then subjected to signal processing by the signal processing unit 21. The timing generation circuit 27 is a processing unit (e.g., a processor or the like) that outputs a pulse signal as a reference for an operation timing to the PDSH 34, the SH 36, the charge-voltage conversion unit 40, and the signal processing unit 21. The PDSH 34 transfers the charges from the solid-state image capturing element 30 to the storage unit 35, and the SH 36 transfers the charges from the storage unit 35 to the charge-voltage conversion unit 40. The charge-voltage conversion unit 40 not only converts charges into a voltage signal but also performs, for example, reset processing of discarding unnecessary charges that are not to be used for image processing.

The signal processing unit 21 performs its predetermined signal processing and outputs the result to the processing unit 12. The signal processing unit 21 performs signal processing such as amplification, filtering, and digitalization (A/D conversion) of an analog pixel signal. For example, the signal processing unit 21 may include an analog front end (AFE).

The image sensor 14 provides (captures) an image by generating charges of an amount corresponding to a light quantity received via the photoelectric conversion elements in the solid-state image capturing element 30 and then converting these generated charges into a voltage signal. The present embodiment shows a solid-state image capturing device 1 that uses a monochrome single-line sensor as the solid-state image capturing element 30.

Next, a read operation of the solid-state image capturing device 1 using a general monochrome single-line sensor will be described.

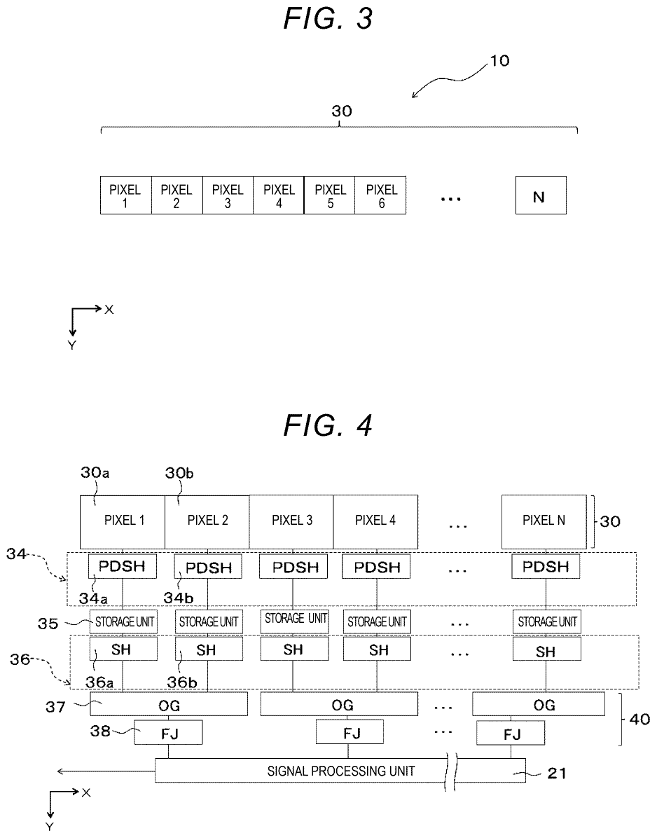

In this embodiment, solid-state image capturing device 1 incorporates a monochrome single-line sensor 10 (a one-dimensional solid-state image capturing element) depicted in FIG. 3. In this example, the monochrome single-line sensor 10 captures light reflected from the subject 19. In other examples, light transmitted through subject 19 may be captured.

The solid-state image capturing element 30 is provided in the monochrome single-line sensor 10. As shown in FIG. 3, in the monochrome single-line sensor 10, pixels provided in solid-state image capturing element 30 are one-dimensionally (linearly) arranged. In this solid-state image capturing device 1, the image of the subject 19 provided by scanning the monochrome single-line sensor 10 in a line-by-line manner across the subject 19 (that is, moving the single-line sensor 10 with respect to the subject 19 in in a direction perpendicular to the pixel row direction). As shown in FIG. 1, the image capturing unit 11 in the solid-state image capturing device 1 incorporates the moving control unit 15a. The moving control unit 15a incorporates a sub-scanning mechanism that moves the monochrome single-line sensor 10 and the subject 19 relative to each other in a sub-scanning direction orthogonal to the direction along which the pixels of solid-state image capturing element 30 are one-dimensionally arranged. The moving control unit 15a may also move the light source unit 13 at the same time. A direction that is orthogonal to the sub-scanning direction in which the monochrome single-line sensor 10 moves will be referred to as a main scanning direction. In the present description, the main scanning direction may also be referred to as an X direction, and the sub-scanning direction may also be referred to as a) direction.

A reading performed once along the X direction corresponds to one line, the moving amount of the sub-scanning mechanism is referred to as a number of lines. A reading refers to a series of processes involving receiving the reflected light from the subject 19 via the solid-state image capturing element 30 to generate charges and convert the charges into a voltage signal, and then transmitting the voltage signal from the signal processing unit 21 to the processing unit 12. A process of storing charges by exposing the monochrome single-line sensor 10 to reflected light from the subject 19 will be referred to as exposure. The exposure time refers to a time in which the monochrome single-line sensor 10 is exposed to light by the reflected light from the subject 19 in the forming of one line of an image of subject 19.

In providing a color image of the subject 19 using the monochrome single-line sensor 10, a color decomposition of three colors including red (R), green (G), and blue (B) is performed by switching the light emission of the light source unit 13. In the following description, R denotes red, G denotes green, and B denotes blue. A reading via the monochrome single-line sensor 10 is sequentially performed for each light color, for example, in an order sequence such as R exposure→G exposure→B exposure. This exposure sequence is performed during line moving in the Y direction. Accordingly, a reading for each color corresponds to one line, and RGB signals for representing a color per pixel can be acquired through a reading corresponding to three lines overlapped. Since reading resolution is determined by pixel density, the pixel density tends to decrease when an exposure of multiple colors must be sequentially performed while moving like the monochrome single-line sensor. In such cases, a spatial shift between lines due to moving causes a color shift and moire effects.

An example of a control configuration of an image sensor 100 according to the first embodiment will be described with reference to FIG. 4. As shown in FIG. 4, the image sensor 100 according to the first embodiment includes a solid-state image capturing element 30 with a plurality of pixels (numbered 1 to N) for acquiring the image, a PDSH 34, a storage unit 35, a SH 36, an output gate (OG) 37, and a floating junction (FJ) 38. In the first embodiment, as shown in FIG. 4, in the solid-state image capturing element 30 odd-numbered pixels (e.g., pixel 1, 3, etc.) will be referred to as an odd-numbered pixel 30a, and even-numbered pixels (e.g., pixel 2, 4, etc.) will be referred to as an even-numbered pixel 30b. In FIG. 3, natural number counting of pixels begins from the left end with the first number being 1. However, the even-numbered pixel and the odd-numbered pixel may be counted from any location or under any scheme, so long as oddness and evenness between directly adjacent pixels along the row direction do not match. Each odd-numbered pixel 30a is provided with a PDSH 34a. Each even-numbered pixel 30b is provided with a PDSH 34b. The PDSH 34a transfers charges for the odd-numbered pixel 30a, and the PDSH 34b transfers charges for the even-numbered pixel 30b. An SH 36a transfers the charges of each odd-numbered pixel 30a to the charge-voltage conversion unit 40, and an SH 36b transfers the charges of each even-numbered pixel 30b to the charge-voltage conversion unit 40. The PDSH 34a may be referred to as a first PDSH 34, and the PDSH 34b may be referred to as a second PDSH 34. The SH 36a may be referred to as a first SH 36, and the SH 36b may be referred to as a second SH 36.

An OG 37 and a FJ 38 are provided in the charge-voltage conversion unit 40 shown in FIG. 2. An OG 37 may be shared by a pair of SH 36a and SH 36b. Each OG 37 receives the charges transferred from the SH 36 and then transfers these charges to a FJ 38. Each OG 37 may have its own respective FJ 38. For example, an appropriate potential barrier is provided between the OG 37 and the SH 36, and charges are efficiently transferred to FJ 38.

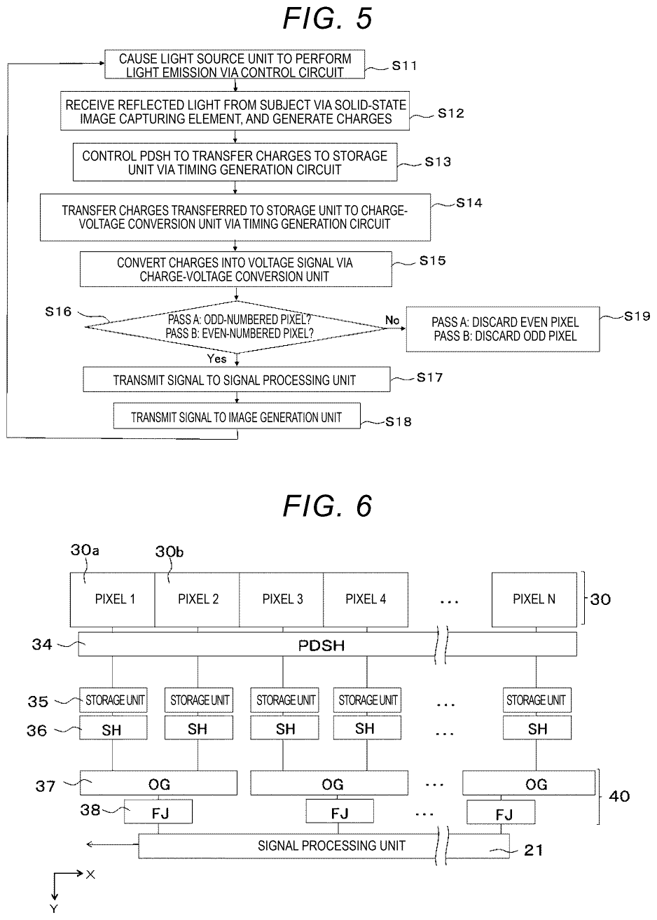

Next, the read operation of an image via the solid-state image capturing device 1 including the image sensor 100 according to the first embodiment will be described with reference to the flowchart in FIG. 5. First, the control circuit 15b causes the light source unit 13 to emit light (step S11 in FIG. 5). Light of one color (selected from the plurality of colors) is emitted. Next, the solid-state image capturing element 30 receives the reflected light from the subject 19 and generates charges (step S12 in FIG. 5). The timing generation circuit 27 controls the PDSH 34 (34a, 34b) to transfer the charges to the storage unit 35 (step S13 in FIG. 5). The timing generation circuit 27 controls the SH 36 to transfer the charges from the storage unit 35 to the charge-voltage conversion unit 40 (step S14 in FIG. 5). The PDSH 34a and the SH 36a handle the transfer of the charges of the odd-numbered pixels 30a, and the PDSH 34b and the SH 36b handle the transfer of the charges of the even-numbered pixels 30b. The timing generation circuit 27 controls individual operations. The charges transferred to the charge-voltage conversion unit 40 are converted into a voltage signal by FJ 38 (step S15 in FIG. 5). As shown in FIG. 5, when a signal is being obtained by the odd-numbered pixel 30a (step S16, PASS A, YES), the pixel signal is transmitted to the signal processing unit 21 and subjected to the signal processing (step S17 in FIG. 5). Then, the processed signal is transmitted to the image generation unit 16 to be used for image generation (step S18 in FIG. 5). However, when a signal is obtained by the even-numbered pixel 30b in PASS A, this pixel signal is discarded (step S19, PASS A). For example, this is reset processing for removing an unnecessary signal and can be performed by the charge-voltage conversion unit 40, and a timing for discarding is controlled by the timing generation circuit 27. The operation for discarding a pixel signal obtained by exposure but not using the signal for image generation will be referred to as a non-exposure operation. The image is read by repeating this series of operations. Next, in an exposure operation, as shown for PASS B in step S16 of FIG. 5, the signal obtained by the even-numbered pixel 30b is used for image generation step S18, and the signal obtained by the odd-numbered pixel is discarded in step S19. Accordingly, in the first embodiment, the exposure and non-exposure operations are alternately repeated for the odd-numbered pixel and the even-numbered pixel. The operation in S18 can be executed when the control circuit 15b switches the light source unit 13 for the next light emission. A light emission timing of the light source unit 13 may be controlled by the light source unit 13 or may be controlled by the control circuit 15b. Similarly, operation timings of the PDSH 34, the SH 36, the charge-voltage conversion unit 40, and the signal processing unit 21 may be controlled by the timing generation circuit 27 or may be controlled by the control circuit 15b.

This operation is executed while the image capturing unit 11 is moved by the moving control unit 15a in the Y direction with respect to the subject 19.

FIG. 6 shows a configuration of an image sensor 200, which is a general monochrome image sensor of a comparative example. In the image sensor 200, a single PDSH 34 transfers charges for all pixels. That is, one unitary PDSH reads the charges stored in the solid-state image capturing element 30 and transfers the charges for all pixels to the storage unit 35. Thus, a sampling cycle of the charges obtained by exposure has the same phase throughout all pixels in the solid-state image capturing element 30 without regard for odd or even numbering thereof.

However, in the image sensor 100 according to the present embodiment, a PDSH structure is separately provided for each of the odd-numbered pixels and the even-numbered pixels. Thus, the phase of the sampling cycle of the charges can be shifted for the odd-numbered pixels and the even-numbered pixels. By acquiring the signal obtained by exposure at different timings for the odd-numbered pixels and the even-numbered pixels, a spatial shift can be further prevented, and a clearer image can be acquired. Furthermore, variations in the additive color synthesis can be increased as the ratio and arrangement of each color during the additive color synthesis affects color expression and visual quality.

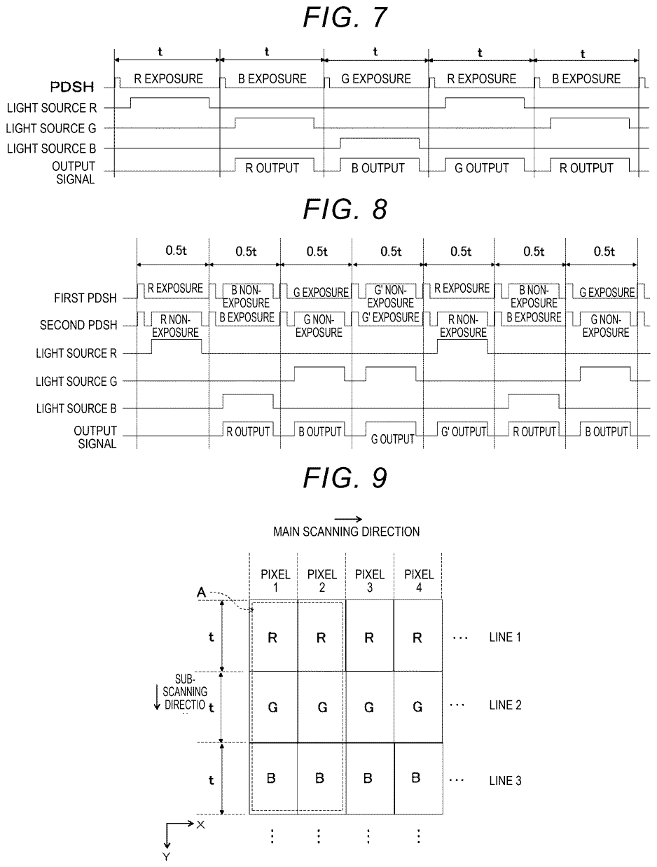

FIG. 7 shows a timing chart illustrating an operation of the image sensor 200 according to the comparative example. FIG. 8 shows a timing chart illustrating an operation of the image sensor 100 according to the first embodiment.

With reference to FIG. 7, in the image sensor 200, the reading of one line is performed for each color in the order of R exposure→G exposure→B exposure by switching the color of the light source unit 13. The signal interval corresponding to the full-line, single-color operation timing of the PDSH 34 is a time t, which is the exposure time required for the light source unit to emit light for every pixel in the solid-state image capturing element 30. One color pixel is generated by adding the three RGB signals obtained by sequentially performing the exposure to each RGB color. Thus, the time required for generating one color pixel in the image sensor 200 is represented by Equation (1):

$$t ( R ) + t ( B ) + t ( G ) = 3 t \qquad Equation ( 1 )$$

As shown in FIG. 7, a signal (an R image signal) based on the charges stored in the solid-state image capturing element 30 according to the light of the first color (R) emitted during a time t is output during the subsequent exposure operation of B light. A signal (a B image signal) based on the charges stored in the solid-state image capturing element 30 according to the light of B emitted during the next time t is output during the subsequent exposure operation of G light. A signal (a G image signal) based on the charges stored according to the light of G emitted during the next time t is output during the subsequent exposure operation of R light. The timing at which the light emission operation of the subsequent color is set to be active (at a high level) is synchronized with the timing of the output operation of the signal obtained for the light of the previous color. This series of operations are performed during line moving (scanning).

However, as shown in FIG. 8, in the image sensor 100 according to the present embodiment, a time t corresponding to a drive timing of the full PDSH 34 of the image sensor 200 according to the comparative example is reduced by half to 0.5t. In accordance with this, the light emission time of the light source unit 13 is also reduced by half. This control can be performed by the control circuit 15b or the timing generation circuit 27. Transfer timings of the charges read by the odd-numbered pixel 30a and the even-numbered pixel 30b are shifted by half of the cycle between the odd-numbered pixels and the even-numbered pixels. When the exposure of the first green is denoted by G (or first G) and the exposure of the second green is denoted by G′ (or second G), the time required for generating one color pixel through additive color synthesis can be represented by Equation (2):

$$0.5 t ( R ) + 0.5 t ( B ) + 0.5 t ( G ) + 0.5 t ( {G}^{′} ) = 2 t \qquad Equation ( 2 )$$

That is, the image sensor 100 according to the present embodiment can reduce the time required for generating one color pixel to ⅔ of the time required by the image sensor 200. In the image sensor 200 according to the comparative example, three pieces (sets) of data of RGB signals are acquired in a period of time equal to 3t. In the first embodiment, four pieces (sets) of data of RGB signals can be acquired in a period of time equal to 2t. Since one more piece of data of the signal obtained by the exposure can be acquired, green (G) light with high visibility is acquired twice in the first embodiment. By setting the signal of G (G signal) with the highest visibility to be used twice that of the R and B signals, the apparent resolution of the image can be increased. This can also contribute to improvement against color shift and moire effects.

As shown in FIG. 8, while the light source unit 13 is emitting the first color R for a certain time, charges associated with R light are stored in the odd-numbered pixel 30a, and these charges are transferred to the storage unit 35 when the PDSH 34a is set to be active (at the high level) after emission of R light is set to be inactive (at a low level). Then, the SH 36a is driven, and the charges are converted into a voltage signal by the charge-voltage conversion unit 40. The output processing of the R signal is performed at a timing at which the light source unit 13 has been switched to the subsequent emission of B light. That is, the timing at which the light emission operation of the next color is set to be active (the high level) is synchronized with the timing of the output operation of the signal obtained for the light of the previous color. For the even-numbered pixel 30b, when R light is emitted, the PDSH 34b is set to be active (at the high level) during the exposure of the odd-numbered pixel 30a, and charges are transferred to the storage unit 35 without being stored for the pixel. When the PDSH 34b is set to be inactive (at the low level), the SH 36b is driven, and charges transferred to the charge-voltage conversion unit 40 are discarded through reset processing. This operation will be referred to as a non-exposure operation. In the next exposure operation of B light, the exposure operation is performed for the even-numbered pixel 30b, and the non-exposure operation is performed for the odd-numbered pixel 30a. For example, the signal that is output (not discarded) is subjected to the additive color synthesis through post-processing by the image generation unit 16. The PDSH 34a or the PDSH 34b may also be driven for the pixel obtained through the non-exposure operation, in synchronization with a timing at which the charges stored through the exposure operation are transferred to the storage unit 35 by the PDSH 34a or the PDSH 34b.

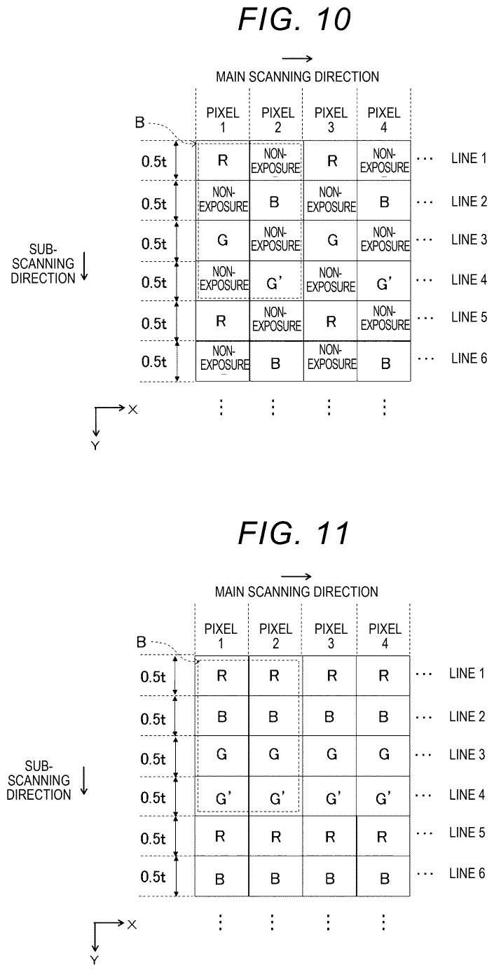

FIG. 9 is an example of a diagram showing a signal pattern of the image sensor 200 according to the comparative example. FIG. 10 is an example of a diagram showing a signal pattern of the image sensor 100 according to the first embodiment. These drawings show pixel color information as acquired by the monochrome single-line sensor 10 over time for each line.

An area A surrounded by a dotted-line portion in FIG. 9 and an area B surrounded by a dotted-line portion in FIG. 10 show an example of an arrangement pattern of signals for performing the additive color synthesis in the image generation unit 16. This synthesis is performed such that two pixels are provided in the X direction, and the signals of each color of R, G, and B are provided in the Y direction. When the same synthesis is performed for the image sensor 200 according to the comparative example, one color pixel is displayed using a signal corresponding to two pixels in the X direction and 3t (three lines) in the Y direction as one block, as shown in FIG. 9. The image sensor 100 according to the first embodiment displays one color pixel using a signal corresponding to two pixels in the X direction and 2t (four lines) in the Y direction as one block, as shown in FIG. 10. The output unit 18 displays the two-dimensional representation of the subject 19 by arranging the blocks in a contiguous manner.

In the image sensor 100 according to the first embodiment, since charges are discarded through the non-exposure operation for one of the odd-numbered pixels 30a or the even-numbered pixels 30b, a pixel for which a signal is not obtained because of the non-exposure operation can be complemented with a signal obtained through the exposure operation of another pixel. That is, as shown in FIG. 11, signals of the same color are duplicated or the like for pixels adjacent to each other in the X direction. For example, this processing is executed by the image generation unit 16. However, an external processor or the like may be used for such processing in some examples.

According to the first embodiment, a pitch between the lines in the Y direction can be set to 0.5t without changing resolution in the X direction. That is, the moving distance in the Y direction required for displaying one color pixel is reduced, and occurrence of a color shift and moire effects can be reduced.

Furthermore, since the non-exposure operation is performed for the odd-numbered pixels and the even-numbered pixels, there will be a color not used for the exposure of each of the odd-numbered pixels and the even-numbered pixels in the Y direction. Thus, a color shift with respect to the color not used for the exposure will not be detected. Accordingly, color shift can be reduced. For example, in the even-numbered pixel in the first embodiment, R and G light are used for the exposure, and there is a period of the non-exposure operation for B light. Thus, a color shift between B and R and between B and G does not occur.

In the first embodiment, since a PDSH 34 is provided for each of the odd-numbered pixels and the even-numbered pixels, the phase of the sampling cycle of the charges can be shifted. The signals acquired by the even-numbered pixel and the signals acquired by the odd-numbered pixel can be transmitted in order. Accordingly, output signals (OS) for controlling transmission of the odd-numbered and even-numbered signals can be combined into one. In the first embodiment, the odd-numbered and even-numbered signals are serially output from the signal processing unit 21 to the processing unit 12. As such, the number of communication lines used for this output can be one or a smaller number because of the serial output, and the number of pieces of wiring can be reduced. In addition, noise reduction is facilitated, and signals can be efficiently transmitted.

Which color is to be acquired for each of the odd-numbered pixels and the even-numbered pixels may be freely selected. The colors are not limited to the present example, and other colors such as white light and infrared (IR) light may be assigned. A color combination for the additive color synthesis of a color pixel and the number of pieces of data constituting one block are not limited to the present embodiment. All of the signals obtained by the exposure may be used, or some of the signals may not be used.

### First Modification Example

Next, a first modification example according to the first embodiment will be described.

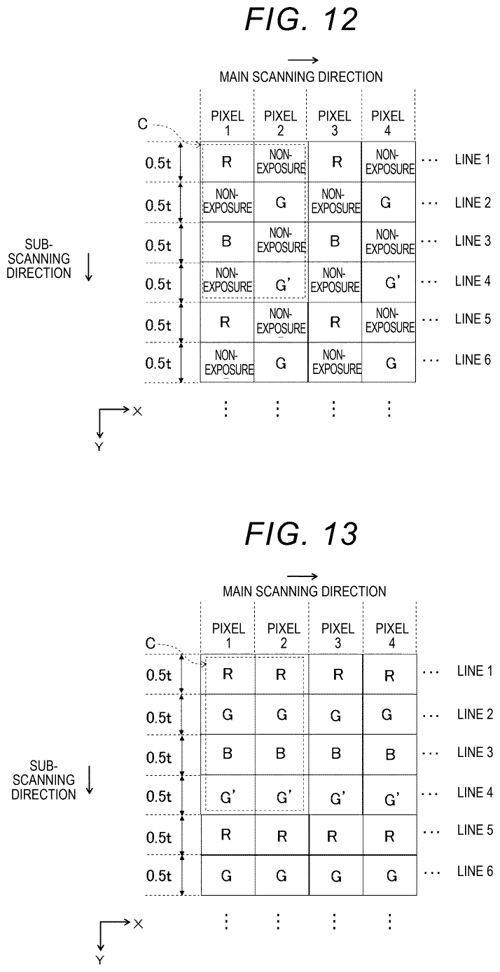

FIG. 12 shows a signal pattern of an image sensor 300 according to a first modification example of the image sensor 100 according to the first embodiment. For convenience, green (G) light exposure after the blue (B) light exposure will be referred to as green (G′) light exposure. As shown in FIG. 12, in the image sensor 300, signals of R and B are acquired for the odd-numbered pixels, and signals of G and G′ are acquired for the even-numbered pixels. An area C surrounded by a dotted line shows an example in which one color pixel is configured with two pixels in the X direction and four lines in the Y direction. In the image sensor 300 according to the modification example of the first embodiment, since charges are discarded through the non-exposure operation in the odd-numbered pixel 30a or the even-numbered pixel 30b, a pixel for which a signal is not obtained because of the non-exposure operation is complemented with a signal obtained through the exposure operation of another pixel. That is, as shown in FIG. 13, signals of the same color are complemented adjacent to each other in the X direction. In the Y direction, B or R is disposed between G and G′. That is, G is not continuously disposed in one set of blocks constituting one color pixel and is disposed in a non-biased pattern. By arranging a large number of G signals with high visibility in a pattern in which G signals are not adjacent to each other in the Y direction, overall color bias is reduced, and a higher quality image can be generated.

As described above, since sampling timings of the charges can be controlled for each of the odd-numbered pixels and the even-numbered pixels, any order of colors to be acquired and any arrangement pattern during the additive color synthesis can be set.

### Second Embodiment

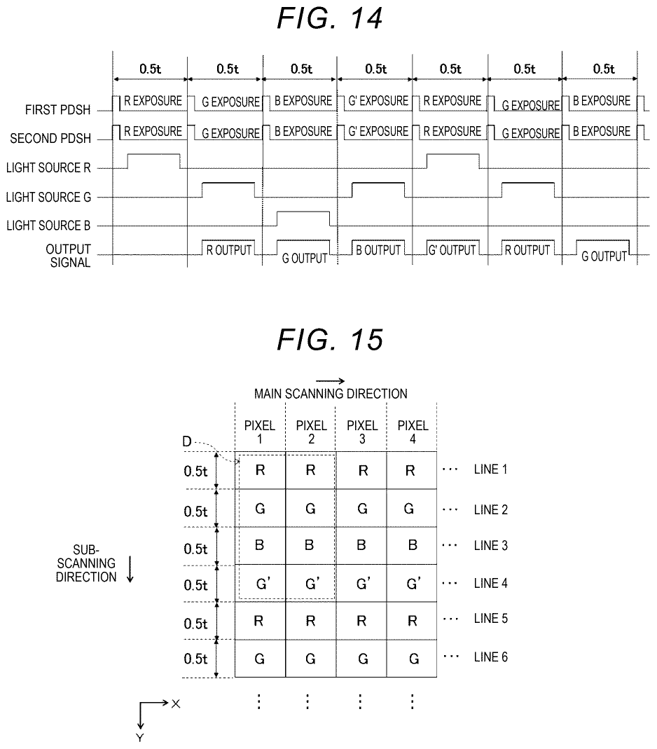

FIG. 14 shows a timing chart of a read operation of an image sensor 400 according to a second embodiment, and FIG. 15 shows an example of a signal pattern of the image sensor 400 according to the second embodiment.

While the second embodiment has the same general sensor configuration as the first embodiment, signals of the odd-numbered pixels and the even-numbered pixels are not discarded. Thus, first and second embodiments differ with respect to the performing of the non-exposure operation. In the second embodiment, since, unlike in the first embodiment, there is no temporary non-exposure state, the brightness level per block unit for displaying a color pixel is not reduced. Furthermore, in the image sensor 400 according to the second embodiment, since both first and second PDSH 34 drive time and the exposure time are reduced compared to those of the image sensor 200 according to the comparative example, a signal acquisition time required for displaying one color image is reduced to ⅔ of that of the image sensor 200 according to the comparative example.

That is, an image sensor 400 that has higher color reproducibility and can reduce a color shift and moire effects compared to the comparative example image sensor 200 is provided.

As shown in FIG. 14, in the image sensor 400, G light with high visibility is acquired twice. The G light signal after the exposure of B light is denoted by G′. An area D surrounded by a dotted line in FIG. 15 shows an example of a signal pattern during the additive color synthesis for displaying one color pixel. The area D surrounded by the dotted line shows an example in which one pixel corresponds to two pixels in the X direction and 2t (four lines) in the Y direction.

With reference to FIG. 15, one of B or R is disposed between G and G′ in the Y direction. That is, G is not continuously disposed along the Y direction in the set of blocks constituting one color pixel and is disposed in a non-biased pattern. By disposing a large number of G signals with high visibility in a pattern in which G signals are not adjacent to each other in the Y direction, overall color bias is reduced as in the image sensor 300, and a higher quality image can be generated.

The image sensors 100, 300, and 400 according to the present embodiment may use infrared (IR) signals as a part of the signals obtained by exposure by further providing the light source unit 13 with a light emission unit that emits an infrared radiation. For example, a solid-state image capturing device using infrared light can be used in a counterfeit banknote determination device, character reading inspection for a printed matter, and the like. This can be implemented by acquiring a signal from the reflected infrared light from the subject 19 that receives the infrared light from the light source unit 13, and analyzing the intensity and pattern of the signals via the processing unit 12 or the external processor or the like that is electrically connected.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An image sensor, comprising:
a plurality of solid-state image capturing elements arranged as pixels in a row;
a storage unit for each solid-state image capturing element to store charges from the respective solid-state image capturing element;
a charge-voltage conversion unit that converts the charges in each storage unit into a voltage signal;
a first photodiode shift gate that transfers charges stored in an odd-numbered pixel of the plurality of solid-state image capturing elements to the respective storage unit;
a second photodiode shift gate that transfers charges stored in an even-numbered pixel of the plurality of solid-state image capturing elements to the respective storage unit;
a first shift gate that transfers the charges stored in the storage unit for the odd-numbered pixel to the charge-voltage conversion unit;
a second shift gate that transfers the charges stored in the storage unit for the even-numbered pixel to the charge-voltage conversion unit; and
a signal processing unit that outputs the voltage signals obtained from the odd-numbered pixels and the even-numbered pixels of the plurality of solid-state image capturing elements.

2. The image sensor according to claim 1, further comprising:
a timing generation circuit that controls operation timings of the first photodiode shift gate, the second photodiode shift gate, the first shift gate, the second shift gate, the charge-voltage conversion unit, and the signal processing unit, wherein
the timing generation circuit controls the operation timings for the odd-numbered pixels and the even-numbered pixels of the plurality of solid-state image capturing elements.

3. The image sensor according to claim 2, wherein signals from the signal processing unit are serially output to an output device.

4. A solid-state image capturing device, comprising:
an image sensor according to claim 2;
a light source unit that selectively emits different color light;
a control circuit that controls a light emission timing of the light source unit and the timing generation circuit; and
an image generation unit that generates an image by synthesizing signals of different color light output from the signal processing unit.

5. The solid-state image capturing device according to claim 4, wherein the image generation unit generates a color pixel for the image by performing additive color synthesis of voltage signals obtained by performing exposure with a red color light, a blue color light, and a green color light.

6. The solid-state image capturing device according to claim 5, wherein the color pixel generated by the additive color synthesis uses two voltage signals obtained by performing two exposures with the green color light.

7. The solid-state image capturing device according to claim 6, wherein the two exposures with the green color light are not performed back to back in an exposure sequence for the color pixel.

8. The solid-state image capturing device according to claim 4, wherein the light source unit emits infrared light.

9. The image sensor according to claim 1, wherein signals from the signal processing unit are serially output to an output device.

10. A solid-state image capturing device, comprising:
an image sensor according to claim 1;
a light source unit that selectively emits different color light;
a control circuit that controls the timing generation circuit and a light emission timing of the light source unit; and
an image generation unit that generates an image by synthesizing signals of different color light output from the signal processing unit.

11. The solid-state image capturing device according to claim 10, wherein the image generation unit generates a color pixel for the image by performing additive color synthesis of voltage signals obtained by performing exposure with a red color light, a blue color light, and a green color light.

12. The solid-state image capturing device according to claim 11, wherein the color pixel generated by the additive color synthesis uses two voltage signals obtained by performing two exposures with the green color light.

13. An image capturing device, comprising:
a multi-color light source;
an image sensor positioned to receive reflected light from an object exposed to light from the multi-color light source, the image sensor including:
a plurality of solid-state image capturing elements arranged as pixels in a row;
a storage unit for each solid-state image capturing element to store charges from the respective solid-state image capturing element;
a charge-voltage conversion unit that converts the charges in each storage unit into a voltage signal;
a first photodiode shift gate that transfers charges stored in an odd-numbered pixel of the plurality of solid-state image capturing elements to the respective storage unit;
a second photodiode shift gate that transfers charges stored in an even-numbered pixel of the plurality of solid-state image capturing elements to the respective storage unit;
a first shift gate that transfers the charges stored in the storage unit for the odd-numbered pixel to the charge-voltage conversion unit;
a second shift gate that transfers the charges stored in the storage unit for the even-numbered pixel to the charge-voltage conversion unit; and
a signal processing unit that outputs the voltage signals obtained from the odd-numbered pixels and the even-numbered pixels of the plurality of solid-state image capturing elements.

14. The image capturing device according to claim 13, further comprising:
a timing generation circuit that controls operation timings of the first photodiode shift gate, the second photodiode shift gate, the first shift gate, the second shift gate, the charge-voltage conversion unit, and the signal processing unit, wherein
the timing generation circuit controls the operation timings for the odd-numbered pixels and the even-numbered pixels of the plurality of solid-state image capturing elements.

15. The image capturing device according to claim 13, wherein the multi-color light source selectively emits red light, blue light, and green light.

16. The image capturing device according to claim 13, wherein the charge-voltage conversion unit includes:
an output gate connected to the first and second shift gate, and
a floating junction unit connected between the output gate and the signal processing unit.

17. The image capturing device according to claim 13, further comprising:
a control circuit that controls the timing generation circuit and a light emission timing of the multi-color light source.

18. The image capturing device according to claim 13, further comprising:
an image generation unit that generates an image by synthesizing signals of different color light output serially from the signal processing unit.

19. A method of controlling a solid-state image capturing device, the method comprising:
causing a light source unit to perform light emission via a control circuit;
transferring charges stored in an odd-numbered pixel of a solid-state image capturing element that receives reflected light of the light source unit to a storage unit for the odd-numbered pixel via a first photodiode shift gate;
transferring charges stored in an even-numbered pixel in the solid-state image capturing element to a storage unit for the even-numbered pixel via a second photodiode shift gate separate from the first photodiode shift gate;
transferring the charges from the storage unit for the odd-numbered pixel to a charge-voltage conversion unit via a first shift gate;
transferring the charges from the storage unit for the even-numbered pixel to the charge-voltage conversion unit via a second shift gate separate from the first shift gate;
shifting an exposure operation timing for each of the odd-numbered pixel and the even-numbered pixel via a timing generation circuit;
converting the transferred charges for the odd-numbered and even-numbered pixels into voltage signals using the charge-voltage conversion unit; and
sequentially outputting the voltage signals obtained for the odd-numbered pixel and the even-numbered pixel via a signal processing unit.

20. The method of controlling a solid-state image capturing device according to claim 19, wherein
transfer charges for the even-numbered pixel generated in a previous light emission to the respective storage unit in synchronization with a timing at which the odd-numbered pixel generates charges by the light emission of the light source unit, and
the charges accumulated for the even-numbered pixel in the present light emission are discarded.
